(19) United States
(12) Patent Application Publication
(10) Pub. No.: US 2003/0038867 A1
(43) Pub. Date: Feb. 27, 2003

(54) Liquid storage container and manufacturing method of liquid storage container

(76) Inventors: Hajime Yamamoto, Kanagawa (JP); Shozo Hattori, Tokyo (JP); Eiichiro Shimizu, Kanagawa (JP); Hiroshi Koshikawa, Kanagawa (JP); Hiroki Hayashi, Kanagawa (JP); Kenji Kitabatake, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/208,869

(22) Filed: Aug. 1, 2002

(30) Foreign Application Priority Data
Aug. 3, 2001 (JP) 236477/2001(PAT.)
Jul. 26, 2002 (JP) 218316/2002(PAT.)

(51) Int. Cl. B41J 2/175

(52) U.S. Cl. 347/86

(57) ABSTRACT

A liquid storage container is here disclosed which comprises an inner wall for forming a liquid storage portion for storing a liquid therein, an outer wall for forming a liquid storage portion housing chamber for housing the liquid storage portion, and a liquid supply portion for supplying a liquid from the liquid storage portion to the outside, wherein the inner wall has a structure in which at least one layer is laminated over the entire inner wall region, and is a member which can deform with discharge of the liquid to generate a negative pressure in the liquid storage portion; the most internal layer of the layers constituting the inner wall of a pinch-off portion is mainly made of a polymer blend of one or more resins selected from polyolefin resins; and these resins are maintained at such a compatible degree as to form a sea-island structure.

### BACKGROUND OF THE INVENTION

1. Field of the Invention

The present invention relates to a liquid storage container which utilizes negative pressure to supply a liquid to the outside and a manufacturing method of the liquid storage container.

2. Related Background Art

It is heretofore known that a container of a multilayered structure made of a synthetic resin is excellent as the container having various unique characteristics. The applicant of the present application has already found that a liquid storage chamber capable of storing a cabinet and a liquid (ink) and capable of generating negative pressure at the time of the discharge of the liquid is integrally obtained by selecting a material which can form a polygonal prismatic shape and which can be peeled between specific layers of the above multilayed structure container. Furthermore, the applicant has also found that a multilayer direct blow molding method is suitable as a manufacturing method of the liquid storage container, and the cabinet and the ink storage chamber can be formed at the same time.

Moreover, in the multilayer peeling direct blow molding container, a weld portion by pinch-off substantially forms a sealed space of an ink storage chamber except an opening intentionally provided as an ink supply port, and in the above cabinet, a pinch-off portion becomes a non-welded structure, which forms an air interconnection port for interconnecting the outside of the ink storage chamber to the air.

The blow molding is extremely suitable for the molding of a hollow container having a small opening at a mouth portion and a large internal volume in many points of productivity and the like. On the other hand, in some cases, it is difficult to similarly maintain the characteristics of the blow molding and the characteristics of the multilayered structure container at the weld and non-welded portions in the pinch-off portion.

Particularly, a negative pressure generation container desirably has a thickness of about 60 to about 300 μm even in the thickest region at the center of a maximum area surface thereof to generate a negative pressure of about −50 to about −150 mmAq. At a liquid supply port, though a more suitable thickness varies depending on a shape of the liquid storage chamber and a flexural modulus of a constitutional material. This flexible ink storage chamber (inner bag) is in a peelable state in the rigid cabinet and is merely spatially retained in a corner portion (corner in which three planes intersect) of the cabinet, while the ink storage chamber is inhibited from falling down within the cabinet. Accordingly, in the negative pressure generation container, it is not desirable from the standpoint of the negative pressure generation container to increase the film thickness of the liquid storage chamber for the generation of the negative pressure in order to increase the strength of the welded portion.

Moreover, for the same purpose, if an projection length of the welded portion at the pinch-off section is increased to increase a welded area, the design of the container is frequently restricted, and in addition, the non-welded opening of the cabinet functions so as to further nip the welded portion of the liquid storage chamber (inner bag). Therefore, the selection of such a constitution is not desirable from the viewpoint of the generation of the stable negative pressure. Particularly in the case that a side length and a pinch-off length of the liquid storage container provided with the pinch-off are relatively close to each other, such a nip phenomenon as cannot be ignored undesirably occurs.

On the other hand, in order to constitute the container by the use of a resin which can suppress its modification into a liquid and which has no skeleton having chloride and the like and which takes environments into consideration, an olefin resin such as a polypropylene which is a general-purpose resin is a suitable material. However, such a material has a defect that it becomes brittle at a low temperature. In addition, the negative pressure generation chamber (inner bag) is thin and is retained in a free state in the cabinet, and simultaneously it stores the amply heavy liquid. Accordingly, under such conditions, there might arise the following problem which should be overcome.

The present inventors have intensively investigated, and as a result, they have found that, under certain conditions, there is a case where the container cannot withstand impact strength by drop or the like, even if the weld strength of the pinch-off portion is sufficient. That is, the weld strength of the welded portion is relatively weak as compared with the strength of a material of a layer constituting a liquid storage portion, and hence, there is a problem that the pinch-off portion is easily torn by impact. This problem is similarly present not only in a material which is within the category of a usually prevalent polyethylene but also in a block copolymer polypropylene in which the impact resistance of the polypropylene at a low temperature is improved. Furthermore, in markets, there have been distributed resins which are each filled with a needle-shaped or layer-shaped inorganic filler, a gummy material or the like. However, it has been made clear that the employment of such resins cannot solve the weakness to the impact and the less strength of the welded portion due to the decrease in an amount of the polymer resin. In addition, such an additive tends to impair the stability of the container to the ink.

On the other hand, when the ink is directly stored in the liquid storage container, the container is constituted in a permeable state so that the state (quantity) of the stored ink can be visibly recognized. In such a liquid storage container, there have been confirmed a phenomenon in which the ink to be used slightly remains on the bottom of the liquid storage container (the bottom of the liquid storage portion), and another phenomenon in which certain components (coloring materials) in the liquid sticks on the wall surface of the liquid storage container. In a state where the ink sticks on the internal wall surface of the liquid storage container in this manner, there has been a case where the visibility of the amount of liquid which remains in the container is deteriorated in spite of the permeable liquid storage container. In particular, the above phenomena appear relatively remarkably when the liquid is held at a high temperature for a long time.

### SUMMARY OF THE INVENTION

The present invention has been developed in view of the above-mentioned circumstances, and it is an object of the present invention to provide a highly reliable liquid storage container which is excellent in stability of a generated negative pressure, a usage efficiency and the consideration of environment and which is endurable to impact by dropping particularly even at a low temperature, and a method for manufacturing the liquid storage container.

Furthermore, it is another object of the present invention to provide a liquid storage container which can impart liquid non-sticking properties to an inner wall of the container and which is improved in liquid discharge properties in addition to the achievement of the above-described objects, and a method for manufacturing the liquid storage container.

For achieving the above-described objects, the present invention is characterized by a liquid storage container comprising an inner wall for forming a liquid storage portion for storing a liquid therein, an outer wall for forming a liquid storage portion housing chamber for housing the liquid storage portion, and a liquid supply portion for supplying a liquid from the liquid storage portion to the outside, wherein the inner wall has a structure in which at least one layer is laminated over the entire inner wall region, and is a member which deforms with discharge of the liquid to generate a negative pressure in the liquid storage portion; the most internal layer of the layers constituting the inner wall of a pinch-off portion is made of a polymer blend of one or more resins selected from the first group, which is usually used as a polypropylene, consisting of a homo-polypropylene (homo-PP), an ethylene-propylene random copolymer (random copolymer PP) and an ethylene-propylene block copolymer (block copolymer PP), and one or more resins selected from the second group, which is usually used as a polyethylene, consisting of a high density polyethylene (HDPE), a medium density polyethylene (MDPE), a low density polyethylene (LDPE), a linear (straight) chain low density polyethylene (LLDPE), a very low density polyethylene (VLDPE) and an ultra high molecular weight polyethylene (UHMWPE); and the first group and the second group are constituted as an aggregate of comparatively large scales.

Further, the present invention is characterized by a liquid storage container comprising an inner wall for forming a liquid storage portion for storing a liquid therein, an outer wall for forming a liquid storage portion housing chamber for housing the liquid storage portion, and a liquid supply portion for supplying the liquid from the liquid storage portion to the outside, wherein the inner wall has a structure in which at least one layer is laminated over the entire inner wall region, and is a member which deforms with discharge of the liquid to generate a negative pressure in the liquid storage portion; and the most internal layer of the layers constituting the inner wall of a pinch-off portion is mainly made of a polymer blend of two or more resins selected from polyolefin resins, and these resins are maintained at such a compatible degree as to form a sea-island structure constituted as an aggregate of comparatively large scales.

Furthermore, the present invention is characterized by a liquid storage container comprising a liquid storage portion for storing a liquid therein, and a liquid supply portion for supplying the liquid from the liquid storage portion to the outside, wherein the inner wall has a structure in which at least one layer is laminated over the entire inner wall region; the most internal layer of the layers is mainly made of a polymer blend of two or more resins selected from polyolefin resins; and these resins are maintained at such a compatible degree as to form a sea-island structure constituted as an aggregate of comparatively large scales.

In addition, the liquid storage container of the present invention is characterized in that a polymer blend of a polypropylene resin and a polyethylene resin is used for the most internal layer.

Moreover, in the liquid storage container of the present invention, the polypropylene resin may be one or more resins selected from the first group, which is usually used as a polypropylene, consisting of a homopolypropylene (homo-PP), an ethylene-propylene random copolymer (random PP) and an ethylene-propylene block copolymer (block PP); and the polyethylene resin may be one or more resins selected from the second group, which is usually used as a polyethylene, consisting of a high density polyethylene (HDPE), a medium density polyethylene (MDPE), a low density polyethylene (LDPE), a linear (straight) chain low density polyethylene (LLDPE), a very low density polyethylene (VLDPE) and an ultra high molecular weight polyethylene (UHMWPE).

According to the liquid storage container of the present invention constituted as described above, the two or more polymers of the same olefin structure have the sea-island structure, and hence, the relatively compatible resins sufficiently adhere to each other in the layer. Additionally, in the pinch-off portion, weld strength between the layers can sufficiently be maintained because the low melting point resin component (the polyethylene resin) is included therein, even if a parison extruded from a die head of a blow molding machine proceeds is cooled until the parison is pinched off in a blow mold.

Moreover, in the most internal layer itself which is integrated by the pinch-off, a major component and a minor component are present in a state wherein large-scale islands are dispersed, and therefore, the impact resistance of the film itself is improved by the island components, whereby the breakage of the film itself can also be prevented.

In this case, the major component, e.g., the polypropylene resin may constitute the sea and the minor component, e.g., the polyethylene resin may constitute the islands, and vice versa. In the case that the ratio of the components is determined to be almost equal, sea-island inversion is apt to occur in regions in the layer, but even in such a case, the effect of the present invention is not fundamentally changed. In the commonly well-known block copolymer PP and the like, it is considered that the impact resistance is enhanced by increasing a ratio of the island component or by farther micro-scaling the island component. However, the impact resistance of such a film-like joint part as in the present constitution, i.e., the pinch-off portion cannot be obtained by a single component layer, and the constitution of the present invention creates an entirely converse effect which cannot be obtained by conventional conception and technology.

Furthermore, on the inner wall surface, the blend resin having the sea-island structure appears as the islands, and hence, surface energy is locally different at the island portions unlike a surface having uniform surface energy. Therefore, a phenomenon such as a water drop on a lotus leaf is obtained, and thus the container is excellent in liquid discharging properties and liquid non-sticking properties.

Additionally, the liquid storage container of the present invention is characterized by the most internal layer using a polymer blend further containing a resin wherein terminal ends of the olefin resin are fluorinated or converted into dimethylsiloxane. A concrete formation procedure of the most internal layer will be described later.

According to the liquid storage container of the present invention constituted as above, there can be obtained not only an effect similar to the polymer blend of the polypropylene resin and the polyethylene resin but also a surface energy difference larger than a difference between the polypropylene resin and the polyethylene resin can be obtained, so that the container is more excellent in the liquid discharging properties and the liquid non-sticking properties.

Moreover, the inner wall of the liquid storage container of the present invention has a laminated structure of two or more layers, and a layer adjacent to the most internal layer is characterized in that a change of its elastic modulus with a temperature change of an environment used for the liquid storage container wherein the liquid is stored in the liquid storage portion is 25% or less.

Furthermore, the layer adjacent to the most internal layer of the liquid storage container according to the present invention may be made of a material having a higher elastic modulus and a lower Izod impact strength than the most internal layer.

Additionally, the layer adjacent to the most internal layer may be made of a cyclic olefin resin, or a random copolymer of ethylene with a tetracyclododecene.

According to the liquid storage container of the present invention constituted as above, the layer adjacent to the most internal layer enhances the stability of the generated negative pressure of the liquid storage portion (internal bag), and the adhesive properties of the most internal layer to the layer are largely contributed especially by one of the sea-island components (e.g., the polyethylene resin), so that all of two or more layers constituting the liquid storage portion become a strongly adhered state, whereby the impact resistance of the pinch-off portion is increased.

In addition, a method for manufacturing a liquid storage container of the present invention is a method for manufacturing a liquid storage container having an inner wall forming a liquid storage portion for storing a liquid therein, an outer wall forming a liquid storage portion housing chamber for housing the liquid storage portion, and a liquid supplying portion for supplying the liquid from the liquid storage portion to the outside, wherein the inner wall is integrally formed together with the outer wall by direct blow molding; the inner wall is a member which can deform with the discharge of the liquid to generate a negative pressure in the liquid storage portion; and the most internal layer of the layers constituting the inner wall of a pinch-off portion (welded portion) is bonded to a resin layer having a sea-island structure constituted as a relatively large scale aggregate containing a polymer blend of two or more resins selected from polyolefin resins.

Moreover, the method may be a method for manufacturing a liquid storage container wherein the most internal layer is made of a polymer blend of a polypropylene resin and a polyethylene resin.

Furthermore, the method may be a method for manufacturing a liquid storage container wherein the most internal layer is made of a polymer blend further containing a resin wherein terminal ends of a olefin resin is fluorinated or converted into dimethylsiloxane.

### BRIEF DESCRIPTION OF THE DRAWINGS

FIGS. 1A, 1B, and 1C are schematic views illustrating one embodiment of a liquid storage container of the present invention.

FIGS. 2A₁, 2A₂, 2B₁, 2B₂, 2C₁, 2C₂, 2D₁, and 2D₂ are schematic views illustrating the change of the liquid storage container shown in FIGS. 1A, 1B, and 1C at the time when an ink is stored and the ink is discharged from the ink supplying portion of the liquid storage container in the order of A to D.

FIGS. 3A, 3B, 3C, and 3D are pattern diagrams illustrating that a polyethylene resin is scattered about a polypropylene resin.

FIG. 4 is a pattern top view illustrating that a polyethylene resin is scattered about a polypropylene resin.

FIG. 5A is a pattern diagram illustrating the liquid attached onto a single material, and FIG. 5B is a pattern diagram illustrating the liquid attached onto a material wherein a polyethylene resin is scattered about a polypropylene resin.

FIGS. 6A, 6B, 6C, 6D, and 6E illustrate the welded portions (pinch-off portion) of the liquid storage container of the present invention. FIGS. 6C, 6D, and 6E are cross-sectional views cut the line C-C.

FIG. 7 is a pattern diagram illustrating a bonding state at the welded portion (pinch-off portion) of the liquid storage container in a pattern manner.

FIGS. 8A, 8B, 8C, and 8D illustrate production steps of the liquid storage container of the present invention.

FIGS. 9A1, 9A2, 9B1, and 9B2 are schematic views illustrating the state of the liquid storage container in each step of production steps of the liquid storage container of the present invention.

FIGS. 10A and 10B are schematic views illustrating other examples of ink supplying system using the liquid storage container of the present invention.

FIG. 11 is a schematic view illustrating one embodiment of the liquid storage container of the present invention explained in Example 2, wherein the inner wall has a three-layer structure.

FIGS. 12A1, 12A2, 12B1, 12B2, 12C1, 12C2, 12D, 12E, and 12F are schematic views of the ink tank of Third Example.

FIGS. 13A, 13B, and 13C explain ink-remaining in Third Example. Although the shapes of tanks are different from each other, the shapes do not influence ink-remaining.

FIGS. 14A, 14B, 14C, 14D, 14E, and 14F are top views and single view drawings illustrating a sea-island structure in a pattern manner.

FIGS. 15A and 15B are schematic views explaining the sea-island structure in a parison state of Second Example.

FIGS. 16A, 16B, 16C, and 16D explain the sea-island structures of the layer cross section of each ink tank of the examples of the present invention.

### DETAILED DESCRIPTION OF THE INVENTION

The following will explain the embodiments of the present invention with reference to the drawings.

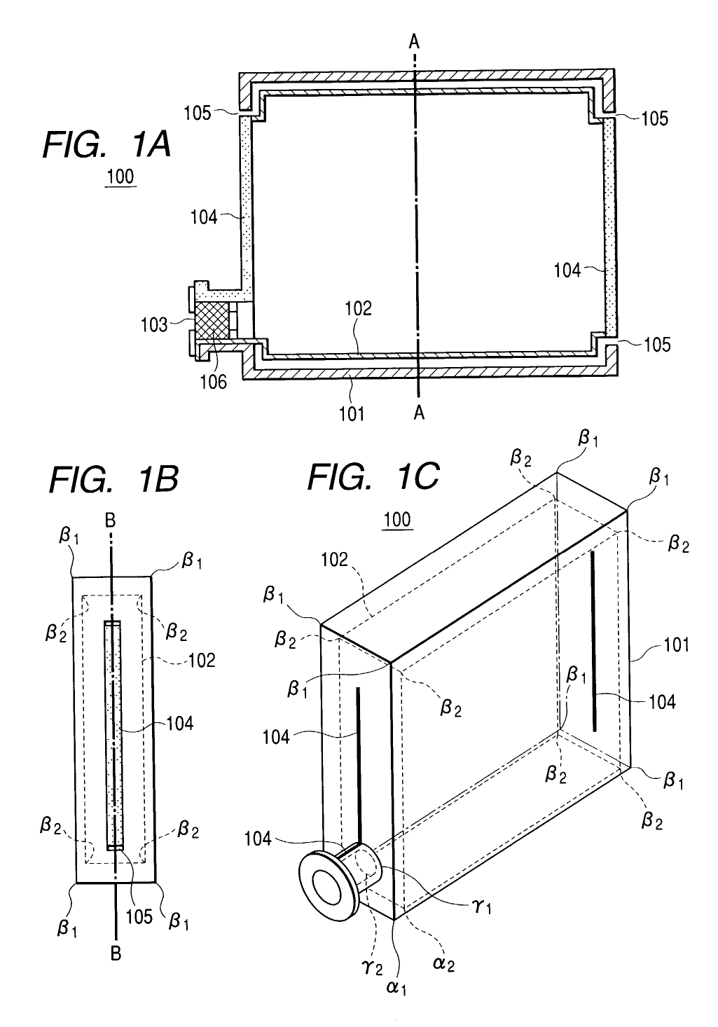

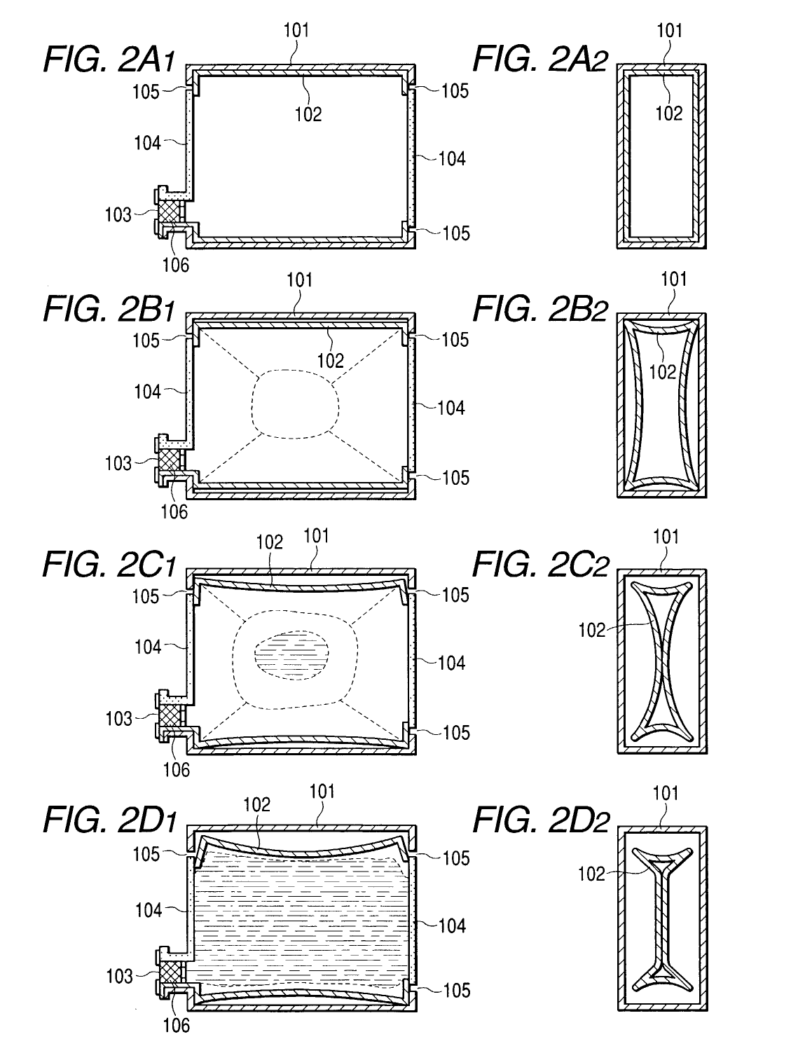

FIGS. 1A, 1B, and 1C are schematic views illustrating one embodiment of the liquid storage container (ink tank) of the present invention, and FIG. 1A is a cross sectional view, FIG. 1B a side view, and FIG. 1C a perspective view. Moreover, FIGS. 2A₁, 2A₂, 2B₁, 2B₂, 2C₁, 2C₂, 2D₁, and 2D₂ are schematic views illustrating the change of the ink tank shown in FIGS. 1A, 1B, and 1C at the time when a liquid (ink) is stored and the ink is discharged from the liquid supplying portion (ink supplying portion) of the ink tank in the order of A to D. Subscript 1 represents that the drawing is a cross sectional view at B-B in FIG. 1B and Subscript 2 represents that the drawing is a cross sectional view at A-A in FIG. 1A.

In ink tank 100 of the present embodiment shown in FIGS. 1A, 1B, and 1C, an ink is stored in the liquid storage portion (hereinafter, sometimes referred to as “ink storage portion”) surrounded by an inner wall 102 separable from an outer wall 101 forming an outer hull. The outer wall 101 is a case which constitutes an ink storage portion housing chamber for housing the liquid storage portion. Moreover, the outer wall 101 is sufficiently thicker than the inner wall 102, and is hardly deformed even when the inner wall is deformed by the discharge of the ink. Furthermore, the inner wall has a welded portion (pinch-off portion) 104, the inner wall is supported such that the wall engages with the outer wall at the welded portion, and the outer wall has an air inlet (air communicating hole) 105 at the above engaging portion.

Now, the ink tank of FIGS. 1A, 1B, and 1C is described in detail. An ink tank 100 is constituted by six surfaces and a cylindrical ink supplying portion 103 is added as a curved surface. Among the six surfaces, the surfaces having the largest area in each inner and outer walls existing both sides of the ink supplying portion 103 are each zoned by four corner portions (α1, β1, β1, and β1) or (α2, β2, β2, and β2).

The thickness of the inner wall surface having the largest area is thin at the parts constituting the corner portions as compared with the central part of each surface of the almost polyangular prism and gradually decreases from the central part of each surface toward each of the corner portions, and thus the inner wall has a convex shape toward the ink storage portion side. In other words, this way is coincident with the direction of surface deformation, and has an effect of accelerating the deformation of the ink storage portion.

Since the corner portion of the inner wall is herein constituted by three surfaces, as a result, the strength of the whole corner portion is relatively stronger than the strength of the central part. Moreover, from the viewpoint of extension of surface, the thickness is thinner than that of the central part, so that the movement of the surfaces mentioned below is permitted. It is desirable that each of the parts constituting the corner portions of the inner wall has an almost equal thickness.

Moreover, the ink supplying portion 103 is connected with an ink discharging tube of an ink-jet recording means which is not shown in the drawing via an ink discharge-permitting member 106 having an ink leakage-preventing function capable of preventing ink leakage when slight vibration or external pressure is exerted on the tank (hereinafter, referred to as “initial state”). The ink supplying portion 103 has a constitution which is difficult to separate the inner wall and the outer wall by the ink discharge-permitting member 106 and the like. Furthermore, since the ink supplying portion is subcylindrical shape, γ1 and γ2 which are crossing portions of the curved surface of the cylinder and the plane surface mentioned below have a property of difficulty to collapse against the deformation of the inner wall accompanying the discharge of the ink by spitting of the ink from usual ink-jet recording means.

In the ink tank of the present embodiment, the ink supplying portion is subcylindrical shape, but is not limited to subcylindrical shape. Since the ink supplying portion is sufficiently small as compared with the ink storage portion, even in the case of polyangular prism shape, the property of difficulty to collapse against the deformation of the inner wall accompanying the discharge of the ink remain unchanged. Therefore, even when the ink is completely consumed, the initial state is maintained at the ink supplying portion without deformation of both of the inner wall and the outer wall.

By the way, since FIGS. 1A, 1B, and 1C and FIGS. 2A₁, 2A₂, 2B₁, 2B₂, 2C₁, 2C₂, 2D₁, and 2D₂ are pattern schematic views, the positional relationship between the outer wall 101 of the ink tank and the inner wall 102 of the ink tank is depicted as if some space is present between them, but it is sufficient that they are in a separable state. Therefore, the inner wall and the outer wall may be in contact with each other or may be constituted such that they are arranged at a minute space. Accordingly, in any cases, in an initial state, the ink tank is formed such that the corner portions α2 and β2 of the inner wall 102 are present at least at the positions corresponding to the corner portions α1 and β1 of the outer wall 101 along the shape of inner surface of the outer wall (FIGS. 2A₁ and 2A₂).

The corner portion herein has a meaning including, in the ink tank constituted by a subpolyhedron, a crossing part of at least three surfaces, more preferably three plane surfaces or a part corresponding to a crossing part of the extended surface. The meanings of the symbols of the corner portion represent that α is a corner portion near to the ink supplying portion among the corner portions formed by the surface having the ink supplying portion, β is other corner portion, Subscript 1 is that of the outer wall and Subscript 2 is that of the inner wall. Moreover, the ink supplying portion is formed as a subcylindrical shape, and when the crossing part of the curved surface of the cylinder and substantial plane surfaces is represented by γ, the outer wall and the inner wall are present at corresponding positions even at the crossing parts, which are represented as γ1 and γ2, respectively. By the way, minute curved surface portions may be formed at the ridgeline portions wherein two plane surfaces are crossed and the corner portions wherein three plane surfaces are crossed. The surfaces in this case are defined, by regarding the minute curved surface portions of the polyhedron as corner portions, as plane surfaces excluding the minute curved surface portions.

After the ink has been spitted out of a recording head and the ink in the ink storage portion has begun to be consumed, the inner wall 102 starts deformation from the central part of the surface having the largest area in the direction to decrease the volume of the ink storage portion. At that time, the outer wall plays a role of suppressing the deformation of the corner portions of the inner wall. Since almost no positional change of the corner portions zoned by the above corner portions α2 and β2 is observed in the present ink tank, an action force of deformation caused by the ink consumption and an action force of shape-returning to the initial state act on the ink storage portion and function in the direction of stabilizing negative pressure.

At that time, the air inlet 105 introduces air between the inner wall 102 and the outer wall 101 and functions the maintenance of stabilized negative pressure at the use of ink without inhibiting the deformation of the inner wall. Since the air inlet 105 is provided at a part of surrounding area of the engaging portion between the welded portion 104 of the inner wall and the outer wall, the space between the inner wall and the outer wall is communicated with outside air via the air inlet (air communicated hole) 105. Thereafter, by balancing the force of the inner wall and the meniscus force at spitting hole of the recording head at a difference of water head, the ink is held in the ink storage portion (FIGS. 2B₁ and 2B₂). By the way, as mentioned above, in the welded portion (pinch-off portion) 104, the outer wall plays a role of suppressing the deformation of the corner portions of the inner wall, but the outer wall does not necessarily inhibit the communication of the air between the outer wall and the inner wall. In the present embodiment, the air inlet 105 is formed utilizing the space between the outer wall and the inner wall at the pinch-off portion. Of course, the air inlet 105 may be independently provided irrespective of the welded portion 104, if necessary.

Furthermore, when a considerable amount of the ink in the ink storage portion is discharged into outside (FIGS. 2C₁ and 2C₂), the ink storage portion is deformed as mentioned above, and a stable collapse wherein the central part of the ink storage portion moves toward inside is maintained. Furthermore, the pinch-off portion 104 also becomes a deformation-regulating part of the inner wall and, with regard to the surface adjacent to the surface having the largest area, a part having no pinch-off portion starts deformation relatively before the region having the pinch-off portion 104 and moves away from the outer wall.

However, by the action of the deformation-regulating part of the inner wall alone, the ink supplying portion may be blocked off through the deformation of the inner wall near to the ink supplying portion and hence there is a possibility that the ink stored in the ink storage portion cannot be sufficiently consumed.

In the present embodiment, since the corner portion α2 of the inner wall shown in FIG. 1C is formed along the corner portion α1 of the outer wall in an initial state, the portion α2 is difficult to deform as compared with other parts of the inner wall at the deformation of the inner wall, and hence the deformation of the inner wall can be regulated by this corner portion. By the way, the inner wall of the present ink tank is expressed such that the angle formed by plurality of the corner portions α2 is 90°.

The angle of the corner part α2 of the inner wall is herein defined as an angle of two surfaces of at least three surfaces constituting the corner portion α1 of the outer wall and having substantially plane shape, i.e., an angle of crossing part of extended two surfaces. The reason why the angle of the corner portion of the inner wall is defined by the angle of the corner portion of the outer wall is because the outer wall is produced on the basis of the outer wall in the production steps mentioned later and has an almost similar figure to the outer wall in an initial state.

As mentioned above, in FIGS. 2C₁ and 2C₂, the corner portion α2 shown in FIG. 1C is positioned at the corner portion α1 of the outer wall in a separable state. On the other hand, the corner portion β2 of the inner wall other than the corner portion near the ink supplying portion among the corner portions formed by the surface having the ink supplying portion is present slightly apart from the corresponding corner portion β1 of the outer wall as compared with α2. However, in the embodiment shown in FIGS. 1A, 1B, and 1C and FIGS. 2A₁, 2A₂, 2B₁, 2B₂, 2C₁, 2C₂, 2D₁, and 2D₂, β's at opposite position are mostly constituted by the angle of 90° or less. Therefore, since the positional relationship of the corner portions with the corresponding outer wall can be maintained at a position near to the position of the initial state as compared with other region of the inner wall forming the ink storage portion, a supplementary support is realized.

Furthermore, in FIGS. 2C₁ and 2C₂, the surfaces having the largest area and opposing to each other are deformed almost at the same time, so that the central parts of the ink storage portion come into contact with each other. The contact portion of the central parts (shaded area in FIGS. 2C₁ and 2D₁) are expanded as the ink is further discharged. That is, in the ink tank of the present embodiment, at the discharge of the ink, the surface having the largest area and the opposite surface (surfaces having the largest area and opposing to each other in the present embodiments) come into contact with each other before an edge formed by the surface of the inner wall having the largest area and an inner wall surface adjacent to the surface having the largest area is folded.

Finally, the whole ink stored in the ink storage portion is almost used up (hereinafter, referred to as “final state”). The state at this time is shown in FIGS. 2D₁ and 2D₂.

In this state, the contact portion of the ink storage portion spreads almost all over the ink storage portion and some of the corner portions β2 are present at the position completely apart from the corresponding corner portions β1 of the outer wall. On the other hand, the corner portion α2 of the inner wall is positioned at the corner portion α1 of the corresponding outer wall in a separable state even in the final state and acts still as a deformation-regulating part until the end.

Furthermore, in the case of this state, depending on the thickness of the inner wall, the pinch-off portion 104 of the inner wall may depart from the outer wall. In that case, since the pinch-off portion 104 has a length component, the deforming direction is restricted. Therefore, even when the pinch-off portion is departed from the outer wall, the deformation is not irregular and proceeds in a well-balanced manner.

The change of the ink tank of the present embodiment at the time when an ink is stored in the ink storage portion and then the ink is discharged from the ink storage portion is as mentioned above, which includes a constitution having a priority order of deformation of the ink tank such that the deformation starts from the surfaces having the largest area, a surface having the largest area come into contact with the opposite surface before the edge formed by the surface having the largest area and an adjacent surface is folded, and then the corner portions other than the corner portions constituted by the surface having the ink storage portion move.

Some supplementary explanations are as follows. The welded portion (pinch-off portion) 104 of the inner wall is provided on the surface having the ink storage portion and the opposite surface and the length is constituted such that it is not less than a half of the width of the above surface but a welded portion is not formed at the corner portion. Moreover, the cylindrical ink storage portion 103 provided on one surface of the above surfaces is constituted such that a part of the portion is positioned at the welded portion.

The following will explain the constitution of the inner wall constituting the container. The inner wall is constituted by polymer-blending a polypropylene resin and a polyethylene resin. The polypropylene resin and polyethylene resin to be used are different in surface energy from each other and the surface energies of both polymers have a relationship:

surface energy of a polypropylene resin<surface energy of a polyethylene resin.

When a material obtained by polymer-blending both polymers is molded by direct blowing, the resins in a compatible state are gradually cooled and solidified. At that time, since a propylene resin has a higher melting point than a polyethylene resin, a polypropylene resin is solidified prior to a polyethylene resin as the resins are cooled. Therefore, the polyethylene resin reaches the surface passing through the solidified polypropylene resin and then is solidified, so that a surface structure wherein a polyethylene resin is scattered about a polypropylene resin is formed. In addition, since a polyethylene resin having a larger surface energy as compared with a polypropylene resin tends to exist on the surface, it is more facile to form a surface structure wherein a polyethylene resin is scattered about a polypropylene resin. The surface structure in this state is hereinafter referred to as a sea-island structure (or southern island structure) for convenience.

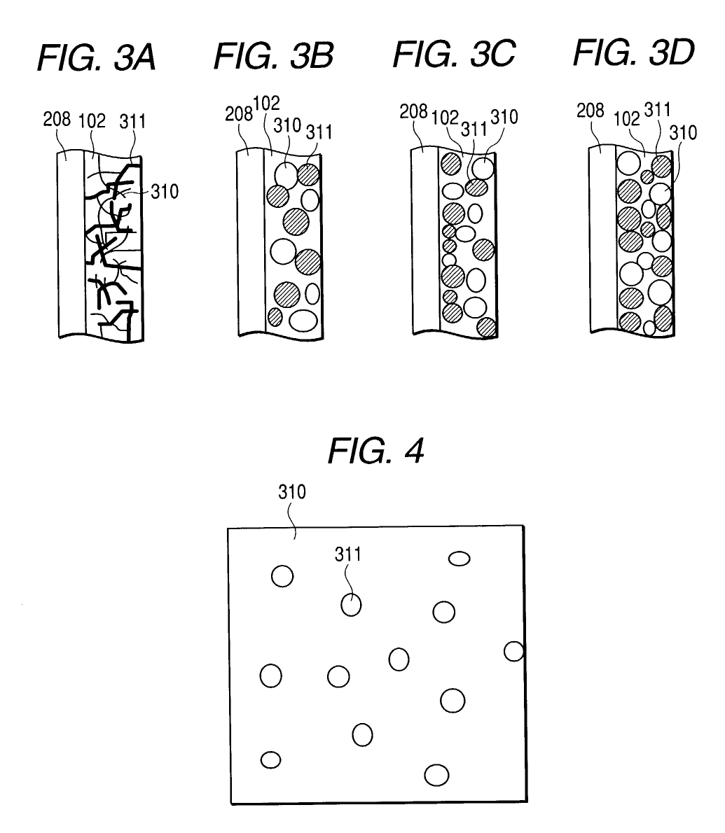

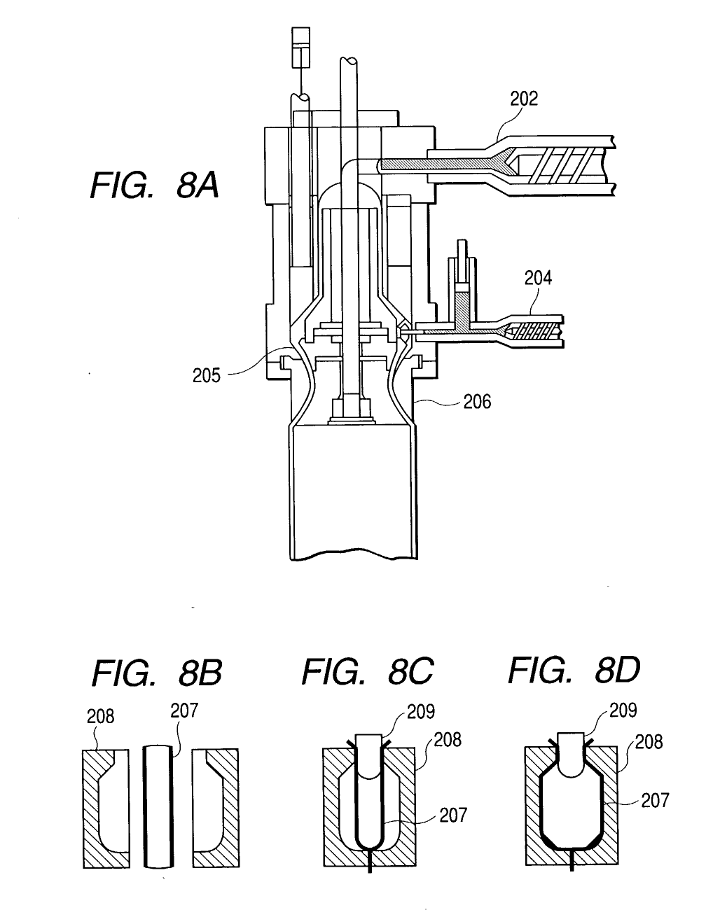

The above description will be further described in detail with reference to drawings. In the description, reference is made with respect to the drawing which schematically shows a portion of a container produced using a direct blowing machine as shown in FIGS. 8A to 8D. FIG. 3A, in which an outer wall is omitted for convenience, shows a condition that an inner wall 102 is situated adjacent to the die 208, and shows the condition illustrating that a polypropylene-based resin 310 indicated by a heavy line and a polyethylene-based resin 311 indicated by a thin line are polymer-blended and their molecules are entangled each other, as an image view. The drawing shows the condition that small-scaled molecules are entangled each other, or forms microscopic aggregates (islands). In the drawing, there is the die 208 forming a mould for the container on an outer side of the inner wall (left side in the drawing).

FIG. 3B shows aggregates constituted of a large number of polypropylene-based resin parts 310 indicated by thick lines shown in a model view of FIG. 3A as black circles, and aggregates constituted of a large number of polyethylene-based resin parts 311 indicated by thin lines as open circles, respectively. FIG. 3B shows the condition just before completion of the blow molding, where the polypropylene-based resin 310 and the polyethylene-based resin 311 exist uniformly in a miscible state over whole area.

FIG. 3C shows the condition that a blow-molding is initially cooled by the die, the die having been cooled to cool and solidify a molten resin for forming a shape, after the blow molding has engaged with the die. The cooled die reduces the temperature of the inner wall 102 firstly from an area close to the die, that is an outer layer resin. Herein, the polypropylene-based resin 310 has a relatively high melting point compared to the polyethylene-based resin 311 (referred to as “high melting point resin” for convenience), or the polyethylene-based resin 311 has a relatively low melting point compared to the polypropylene-based resin 311 (referred to as “low melting point resin” for convenience). Therefore, the polypropylene-based resin as the high melting point resin, which forms the portion of the inner wall close to the die, first starts to solidify according to the temperature reduction of the die. Then, the polyethylene-based resin as the low melting point resin subsequently solidifies according to the temperature reduction. With progress of the cooling, the inside of the inner wall (opposite side to the die positioning side) also solidifies. The inside of the inner wall solidifies more slowly than the outside (the die positioning side), and thus a difference of solidification rates occurs between the polyethylene-based resin 311 and the polypropylene-based resin 310, which, cooperating with the difference of their surface energies, makes it easy to arrange the polyethylene resin 311 on a surface, and a mutually independent structure (southern island structure) becomes more clear. The southern island structure is schematically shown in FIG. 4. In the structure of this drawing, the polypropylene-based resin (sea component: 310) constitutes major surface in which the polyethylene-based resin areas (island component: 311) are scattered.

This structure is produced by a situation that the polypropylene-based resin and the polyethylene-based resin exist mixedly on a comparatively large scale. Although the mixing ratio is not always specified, it is not so preferable that the polyethylene-based resin occupies the greater part because effects of the impact resistance of the polypropylene-based resin may not be obtained. In a range that the ratio of the two resins changes from 20% of the polypropylene-based resin (i.e. 80% of the polyethylene-based resin, in this case the southern island structure is such that the polypropylene-based resins are scattered in the polyethylene-based resin) to 80% of the polypropylene-based resin (i.e. 20% of the polyethylene-based resin, in this case the southern island structure is such that the polyethylene-based resins are scattered in the polypropylene-based resin), a refining of the inside, the object of this invention, can be achieved (because there are enough number of scattered areas having difference of the surface energies) and a bond strength at the pinch-off portion can be secured. The surface condition also changes depending on other conditions such as a temperature reduction condition during cooling and the like, in addition to the blend ratio of materials. Accordingly, it is important that the blend ratio and the temperature process conditions are properly selected depending on respective finishing machines in order to obtain a desired surface condition.

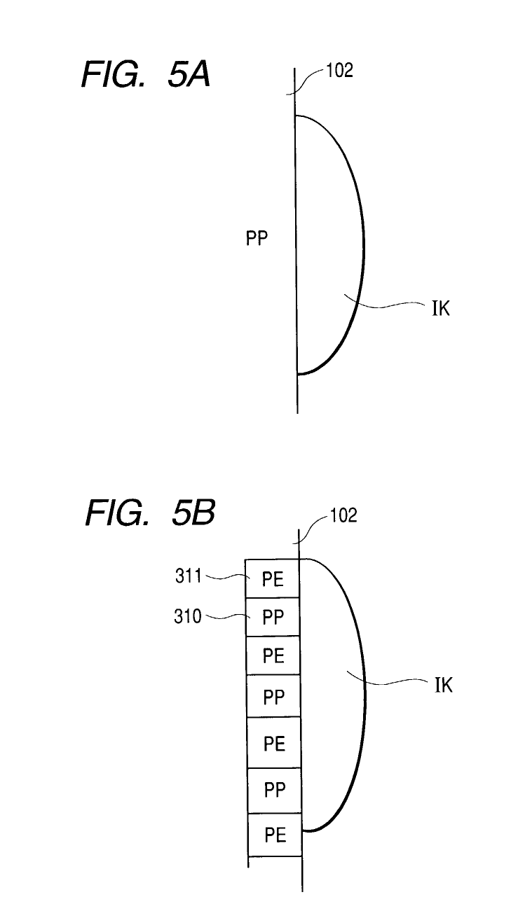

A description is made on the refining of the inside using FIGS. 5A and 5B. FIG. 5A schematically shows an aspect of liquid contact of ink IK to the inside wall 102 of the liquid storage container constituted from a single material or the polypropylene-based resin (PP) in the drawing, and shows the condition that a single droplet IK is adhered to the inner wall 102. When the liquid storage container is constituted from the polypropylene-based resin only, an entire surface to which the ink droplet contacts is the area of the polypropylene-based resin only, therefore the surface energy condition of the contact surface is much stable and the ink droplet tends to reside thereon. On the contrary, as shown in FIG. 5B, for the inner wall 102 of the liquid storage container where the polypropylene-based resin 310 (PP) and the polyethylene-based resin 311 (PE) are blended, the polypropylene-based resin and the polyethylene-based resin exist mixedly at the contact surface with one single ink droplet, the contact condition of the ink droplet becomes extremely unstable because their surface energies are different term each other, in addition, the difference of the surface energies (i.e., difference of the wettability to the ink) generates a force which shifts the ink toward a direction where entropy increases, leading to an easy shift. As a result, coloring materials scarcely reside on the inside wall surface, and a reduction of visibility due to an adhesion of the coloring materials can be prevented.

Next, examples of ink tanks of the aforementioned embodiments are described.

### EXAMPLES

### First Example

For the ink-tank 100 shown in FIGS. 1A to 1C, in which each of the materials forming the inside wall 102 is varied, a strength of the pinch-off portion, a local hydrostatic pressure test of the tank, and a tear resistance of the pinch-off portion based on a drop and impact were examined.

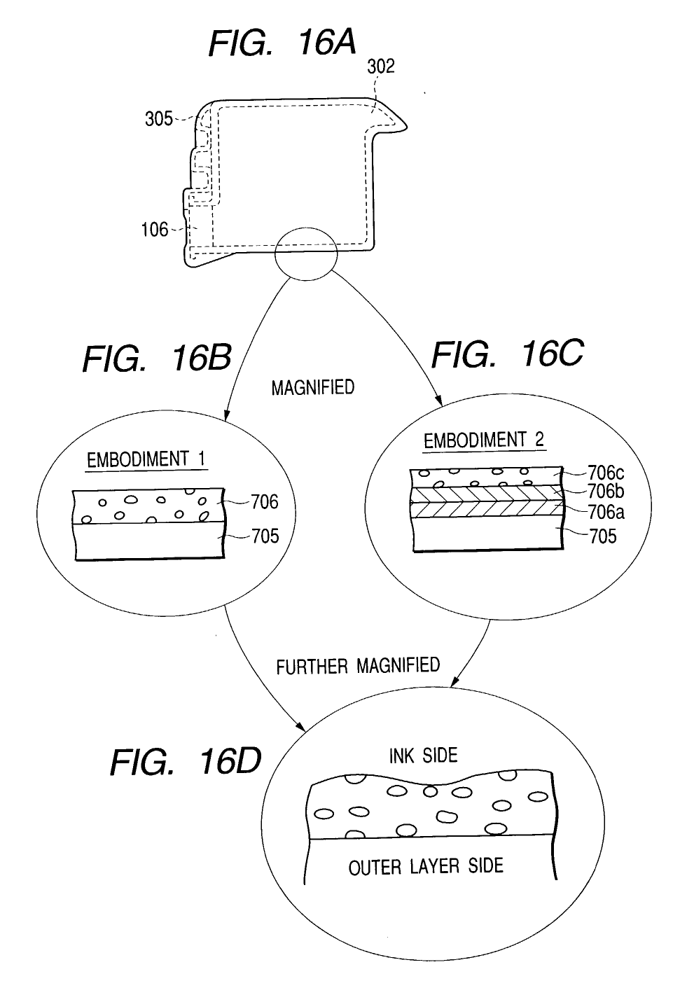

FIG. 16B shows a schematic view showing a magnified portion of the ink tank 100. Moreover, FIG. 16D shows a further magnified view of the portion. In the constitution, an outer layer 705 and an inner layer 706 are stacked, the inner layer 706 is constituted from the polypropylene resin 310 and the polyethylene resin 311 which is scattered in the polypropylene 310. When the weight of such constituted ink tank is 15 g (ink weight is 13 g), the outer wall layer (body layer) 101 is of an impact resistive polystyrene HIPS, the thickness of the center of the maximum area surface (hereinafter, refer to as “maximum thickness”) is 1 mm, the width of the ink tank is about 10 mm, the depth is about 40 mm, the height is about 35 mm, and the thickness of the center of the maximum area surface of the inner wall 102 is about 150 μm, following results, shown in Table 1, are obtained.

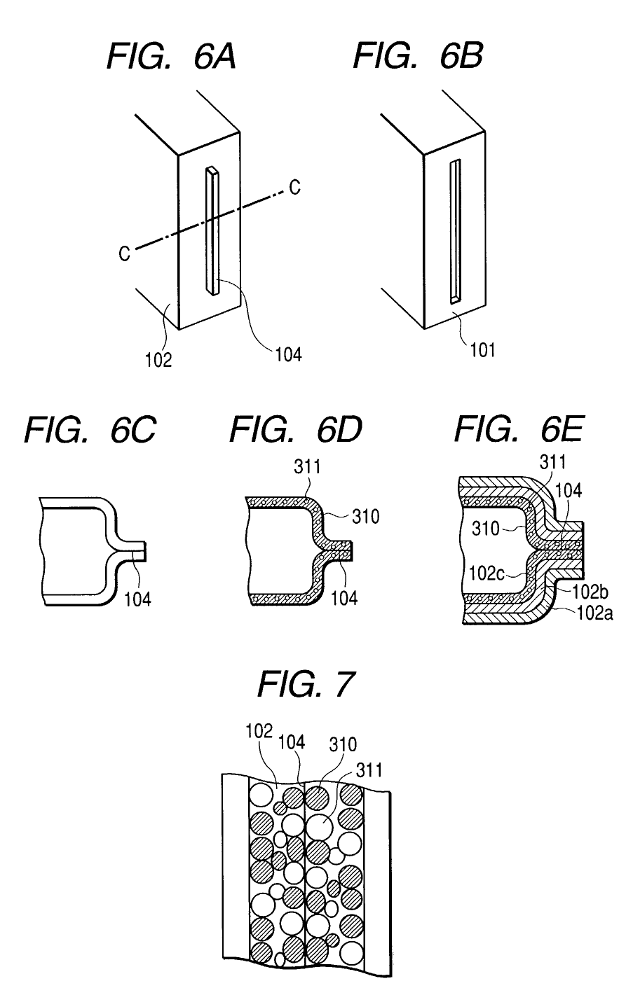

FIGS. 6A to 6E are the views for describing the welding portion (pinch-off portion) of the liquid storage container of the present invention, and an outline of the pinch-off portion of this example corresponds to that shown in FIG. 6D. FIG. 7 shows a partially magnified, schematic view of the pinch-off portion. The polyethylene resin situates on a bonded surface of the inner wall 102, and even if the portion tends to be cooled relatively fast by the die compared with other parts, each of the polyethylene resins having low melting points interposes and firmly bonds each of the inner layers, so a bonding performance of the pinch-off portion will improve.

In the local hydrostatic pressure test of the tank, damage conditions of the pinch-off portion and the like were examined under load of 30 kgf for 30 seconds for the area 15 in diameter at the center of the maximum area surface, resultantly no disorder such as the tear was found in either of the examples and the comparative examples despite of the test temperature, therefore the test results are omitted from Table 1. In addition, for the drop and impact resistance strength, the disorder mode was found as the tear of the pinch-off portion in all examples, and a particular mild drop condition as the test condition was in a case that one face opposed to the other face having an ink supply portion thereon was caused to freely fall such that it impacted against a lauan material or a P-tile floor.

Each of resins in Comparative Examples 1, 2, 4 used herein are same as in corresponding Examples A, B, C respectively. Specifically, a homo-PP, used in Example A and Comparative Example 1, is one that MFR is about 15 g/10 min, similarly a HDPE, in Example A and Comparative Example 4, has the MFR of about 10 to 12, and a random copolymer PP, in Examples B, C and Comparative Example 2, has the MFR of 28 to 30. Those resins are listed in the table as representatives. The MFR (Melt Flow Rate), which is defined in JIS K7210 as an index indicating a melt viscosity of the resin, typically relates inversely to weight average molecular weight Mw. When the weight average molecular weight or molecular weight distribution is shifted toward a low molecular weight side, the MFR tends to increase. For example, the weight average molecular weight of the random copolymer PP having the MFR of 28 to 30 g/10 min is about 200 to 500 thousands.

Further supplementary description is made. The random copolymer PP used in Examples B and c has an Izod impact strengths of about 4.5 at 23° C., and about 2.5 at 0° C. That is, the strength of the welding portion, as well as the strength of the material as the layer, is improved significantly due to advantages of the invention, even though it is a very weak material against impact.

TABLE 1

| | | Pinch- | Drop and impact resistance | |
|---|---|---|---|---|
| | Inner wall | off | strength (mm at ° C.) | |
| | layer | strength | Lauan | |
| | material | (gf/mm) | material | P-tile |
| Example A | Homo-PP 75%, | >80 | >1,600 at 5 | >1,200 at 5 |
| | HDPE 25% | | | |
| Example B | Homo-PP 50%, | >80 | >1,600 at 5 | >900 at 5 |
| | Random PP | | | |
| | 50% | | | |
| Example C | Homo-PP 50%, | >80 | >1,600 at 5 | >1,000 at 5 |
| | Random PP | | | |
| | (Nucleation | | | |
| | agent 0.5%) | | | |
| | 50% | | | |
| Comparative | Homo-PP | >50 | >1,200 at 15 | >900 at 25; |
| Example 1 | | | | <300 at 5 |
| Comparative | Random PP | >50 | >1,200 at 15 | >900 at 25; |
| Example 2 | | | | <400 at 5 |
| Comparative | Block PP | >50 | >1,200 at 15 | >900 at 25; |
| Example 3 | | | | <400 at 5 |
| Comparative | HDPE | >50 | >1,200 at 15 | >900 at 25; |
| Example 4 | | | | <500 at 5 |
| Comparative | LLDPE | >50 | >1,200 at 15 | >900 at 25; |
| Example 5 | | | | <500 at 5 |

In all the examples, a good peeling property can be obtained between the outer wall and the inner wall, and a desired negative pressure characteristic can be also obtained. However, as shown in Table 1 above, in Comparative Example 1 to 5 where respective layers welded at the pinch-off portions are of single composition systems, when the face having the pinch-off portion was impacted in the drop-to-P tile at 5° C., in some cases the pinch-off portion might tear and the ink might escape in all the comparative examples. As shown in Table 1, no large significant difference exists in the welding strength of the pinch-off portion, and an external force that is not always correlated to the strength is added instantaneously during the drop and impact. From this, as a result of making every effort, in cases that two or more types of resins having proper miscibility are blended as in Examples A to C, a good impact resistance, which is never achieved in a single resin system, could be obtained, certainly in a normal temperature, even in a low temperature environment such as 15° C. and 5° C. In this table, the result shows that the ink stored within the inner wall fills substantially full space (13 g), however even in the case of the tank in use, the result shows similar tendency although the impact thereon is slightly gentle.

That is, in the first example, a sea-island structure is formed in the most internal layer by blending two or more types of resins having a proper miscibility, thereby increase of the impact resistance strength may be designed by the material itself, and increase of the welding strength of the pinch-off portion may be also designed by each of such layers. Thus, the impact resistance, one important function as the thin inner wall for storing the ink within the ink tank, was improved in addition to the welding strength of the pinch-off portion. The welding portion of the inner wall receives the impact transmitted directly from the outer walls sandwiching the welding portion, therefore in case the engagement portion is provided on a face considerably long relative to the face, the advantages exhibits more effectively than other means.

Comparing Example B with Example C, the random copolymer PP in Example C, in which a nucleation agent is highly added typically for adding transparency (in this example, 3 to 4% of ethylene content), exemplifies the case that a secondary effect could be confirmed depending on refining conditions in crystallization.

Hereinafter, the advantages confirmed in the first example are reconsidered from another view angle.

When the strength problem exists in the outer wall itself, since the outer wall itself never contacts directly to the stored liquid, the problem can be solved by means of a design method for selecting the materials having the high Izod-impact strength or for increasing the thickness, however contrarily to the outer wall, in case of the thin inner wall, which is transformable and functional for generating the stable negative pressure, generally the problem was hardly solved.

That is to say, in case a consideration is made particularly on the ink tank as the liquid storage, the materials which never affects on the ink composition when they contact with the ink are required. Further, in taking account of the material cost and a recycling capability, the olefin-based material, particularly the polypropylene is a preferable choice, on the other hand, generally the polypropylene has a poor impact resistance, and increasing the thickness of the most internal layer until obtaining the desired impact resistance affects on the thickness and stiffness of the entire inner wall, and it is not a selectable solution for the inner wall having an appropriate negative pressure generating function.

However, according to a novel idea, the present invention succeeded in providing the internal layer which keeps its sealing performance even when the drop and the impact are given, due to bonding each of the most internal layers, and even in the region forming the sealing structure or the pinch-off portion as the region having the lowest impact resistance performance, while keeping the liquid contact property.

### Second Example

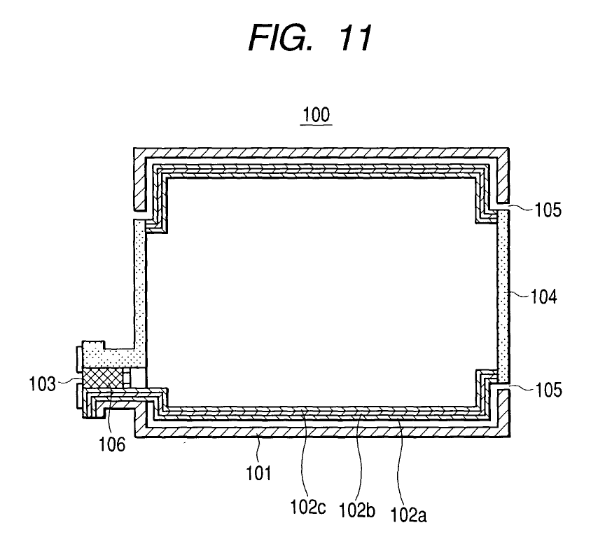

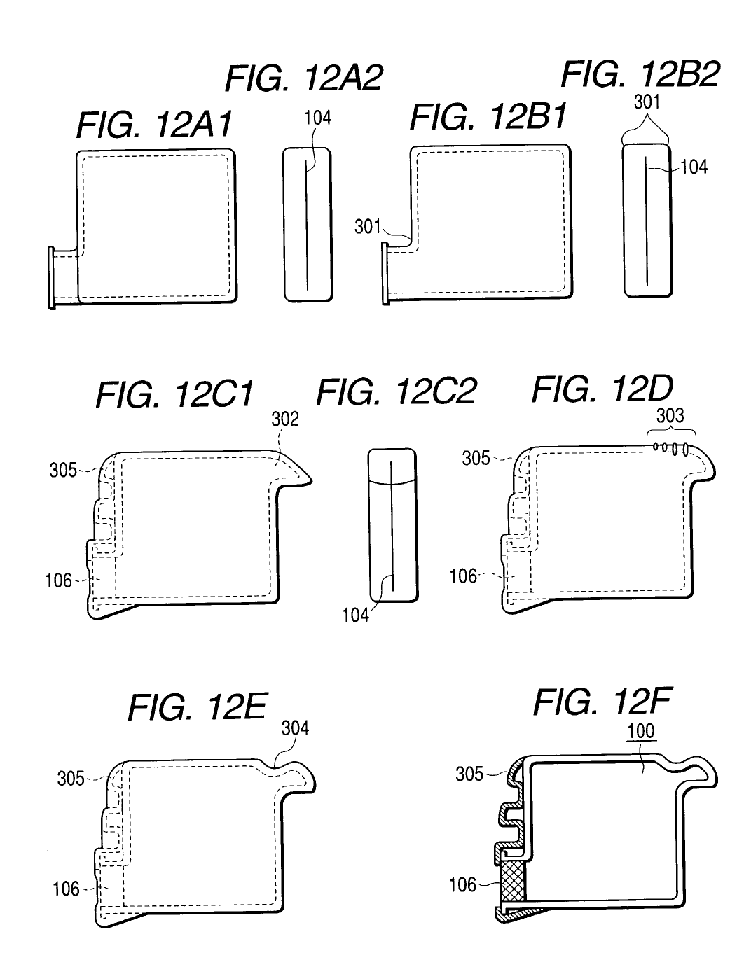

The second example is described using FIG. 11 and FIG. 16C. When the ink tank 100 was constituted of an ethylene-propylene block copolymer (block PP) as a component of the outer wall 101 (705), and as the components of the inner wall 102 (702), an ethylene-vinyl alcohol copolymer (EVOH) (thickness of 15 μm) as an oxygen permeation resistance layer (gas barrier layer) 102a (706a), an amorphous polyolefin APO (thickness of 90 μm) as an ambient-temperature-change resistance layer 102b (706b), and the most internal layer (thickness of 20 μm) 102c (706c) having a varying material composition in turn from the layer adjacent to the outer wall. The resultant strengths of respective pinch-off portions of the ink tank were as in the following Table 2.

As the material for the amorphous polyolefin APO layer adjacent to the most internal layer 102c (706c), specifically a cycloolefin resin including the olefin in cyclic structure constituting the random copolymer (cycloolefin polymer (CPO)) is desirable, herein Apel (Model: APL6509) by Mitsui Kagaku Co., Ltd., which is a random copolymer of ethylene and tetracyclododecene genus, was used. Same types of materials can be selected from Zeonex by Nihon Zeon. The schematic view of this three-layers-structure of inner wall is shown in FIG. 11 and FIG. 16C.

TABLE 2

| | | | Drop and impact resistance | |
|---|---|---|---|---|
| | Most internal | Pinch-off | strength (mm at ° C.) | |
| | wall layer | strength | Lauan | |
| | material | (gf/mm) | material | P-tile |
| Example D | Random PP | >80 | >1,200 at 5 | >900 at 5 |
| | (Nucleation | | | |
| | agent 0.5%) | | | |
| | 75%, | | | |
| | HDPE 25% | | | |
| Example E | Random PP | >80 | >1,200 at 5 | >1,000 at 5 |
| | (Nucleation | | | |
| | agent 0.5%) | | | |
| | 50%, | | | |
| | HDPE 50% | | | |
| Comparative | Random PP | >80 | >1,200 at 25 | >900 at 25; |
| Example 6 | (Nucleation | | | >500 at 5 |
| | agent 0.5%) | | | |
| | 50%, | | | |
| | Homo PP 50% | | | |
| Comparative | Random PP | >40 | >900 at 25 | <750 at 25; |
| Example 7 | (Nucleation | | | <300 at 5 |
| | agent 0.5%) | | | |

As shown in above Table 2, when the blend system having the high density polyethylene (HDPE) is used, relative to the ambient-temperature-resistance layer having the ethylene skeleton as its main structure, for the most internal layer adjacent to the ambient-temperature-resistance layer, the impact resistance is further improved compared to that of Comparative Example 4. This is because an impact absorbable constitution as an integrated layer having a larger thickness (100 μm or more) is formed due to the improvement of the adhesion strength to the adjacent APO layer, in addition to the improvement of the impact resistance performance of the most internal layer itself and improvement of the welding strength of the pinch-off portion as shown in the first example. Moreover, this constitution restraints the tear of the APO layer itself, which is hard but comparatively brittle (weak against impact), or the tear following peeling from the most internal layer.

A supplementary explanation is made further in detail. The amorphous polyolefin (APO), particularly the random copolymer of the ethylene and the tetracyclododecene genus as a preferable example, can be given for the ambient temperature resistance layer. It is rather miscible with the polyethylene-based resin than the polypropylene-based resin (homopolypropylene (homo-PP)), ethylene-propylene random copolymer (random PP), and ethylene-propylene block copolymer (block PP) based on its main skeletal structure. It is found that the HDPE arranged as the islands in the most internal layer exhibits a higher adhesion strength to the APO as the adjacent layer, thereby separation at interface, in addition to rupture of the pinch-off portion of the most internal layer, becomes impossible. Therefore, the advantage of the improvement of the impact resistance due to a coalesce of at least two layers can be obtained, in addition to the improvement of the impact resistance of the most internal layer itself, the coalesce being caused by the improvement of adhesion property to the ambient-temperature-change resistance layer adjacently bonded to the most internal layer.

Naturally, it may exhibit a similar advantage that the ambient-temperature-change resistance layer (hereinafter, it may be referred to as “interlayer”) is blended with the adhesive component, however the present invention provides a freedom that the adhesive component for getting a larger adhesive effect on both of the most internal layer and its opposite layer interposed by the interlayer can be selected.

### Third Example

In the third example, the drop test was performed in a configuration that other functions required for practical products were added. The layer constitution of the materials for the outer and inner walls were equal to those in Example D. The drop test was performed in a way that corner portions and ridgeline portions were finished with spherical machining of R3, respective types including no ID (identification member corresponding to color data of the ink tank and the like)/no grip type ((a) and (b)), ID/corner grip type (c), ID/knurling grip type (d), and ID/concave grip type (e), were made, and their hit faces at the drop and impact of the ink tank were varied, or the weight of the ink tank was varied (two and three times in width direction). The advantages of the present invention were obtained in any types.

In the drawing, (f) shows a cross section of (e). A convex portion is provided in the position where the ink tank is installed appropriately corresponding to a concave portion of ID305.

TABLE 3

| | | | | Drop and |
|---|---|---|---|---|
| | | | | impact |
| | | | Ridgeline | resistance |
| | ID | Grip shape | roundness | strength |
| Example D | Absent | Absent | <R1 | Effective |
| Example F | Absent | Absent | R3 | Effective |
| Example G | Present | Triangle shape | R3 | Effective |
| | | | (Grip is R1) | |
| Example H | Present | Knurling state | R3 | Effective |
| Example J | Present | Round concave | R3 | Effective |
| | | shape | | |

### Fourth Example

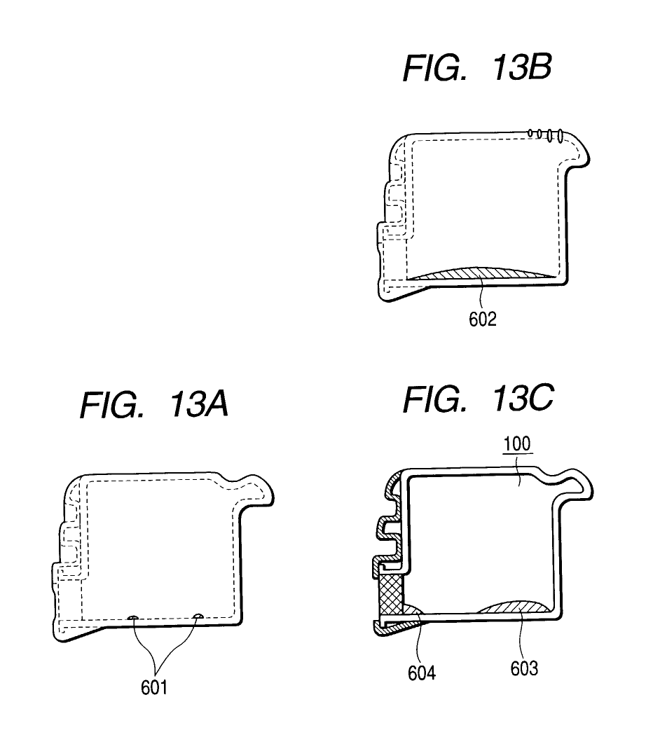

This example describes another advantage of the present invention. When the ink tanks 100 shown in FIGS. 1A to 1C were constituted varying respective components of the inner walls 102, the maximum amount of the ink remained within the ink storage (refer to FIG. 13B), and the ink component after preserving in the ambient temperature of 70° C. for one month, particularly a sticking property of the coloring material component (evaluation on a scale of good 6 to bad 1 for visibility, practically four or more are available) were examined.

Regarding the ink, mainly two types of ink, such as a carbon black pigment ink (surface tension of 4.4 mPa·s) and a permeating dye black ink with surfactant (surface tension of 32 mPa·s) were examined. Although difference was found according to the pigment type and the dye type, or the adding density, or the solvent composition, in this example, sufficient advantages to cover those differences were confirmed. They are shown in Table 4.

TABLE 4

| | | | sticking property | |
|---|---|---|---|---|
| | | | level after | |
| | Most internal | Amount of | 1 month at 70° C. | |
| | all layer | remaining ink (g) | Pigment | Dye |
| | material | [its case] | ink | ink |
| Example P | Homo-PP 75%, | <<0.1 [Maximum, 1 | 4 | 6 |
| | HDPE 25% | drop level] | | |
| Example Q | Homo-PP 25%, | <0.1 | 4 | 6 |
| | HDPE 75% | | | |
| Example R | Homo-PP 70%, | <<0.1 [Maximum, 1 | 4 | 6 |
| | LLDPE 30% | drop level] | | |
| Example S | homo-PP 40%, | <<0.1 [Maximum, 1 | 6 | 6 |
| | terminal- | drop level] | | |
| | fluorinated PE | | | |
| | 60% (water | | | |
| | repellency, oil | | | |
| | repellency) | | | |
| Example T | homo-PP 40%, | <<0.1 [Maximum, 1 | 5 | 6 |
| | terminal- | drop level] | | |
| | silicone | | | |
| | modified PE 60% | | | |
| | (water | | | |
| | repellency) | | | |
| Comparative | Homo-PP | <0.5 [Pigment ink | 1 | 5 |
| Example 8 | | was separated] | | |
| Comparative | HDPE | <0.5 [Remaining | 1 | 4 |
| Example 9 | | dye ink was | | |
| | | slightly more | | |
| | | than in | | |
| | | Comparative | | |
| | | Example 8] | | |
| Comparative | Internal wall | <0.1 | 2 | 6 |
| Example 10 | surface was | | | |
| | coated with | | | |
| | Fluorination | | | |
| | resin (Water | | | |
| | repellency, Oil | | | |
| | repellency) | | | |
| Comparative | Internal wall | <0.1 | 2 | 6 |
| Example 11 | surface was | | | |
| | coated with | | | |
| | silicone resin | | | |
| | (Water | | | |
| | repellency) | | | |
| Comparative | Internal wall | <0.7 [Pigment ink | 1 | 5 |
| Example 12 | surface was | was stuck] | | |
| | coated with | | | |
| | silicone resin | | | |
| | (hydrophilic) | | | |

As shown in above Table 4, although it looks better for ink remaining as a tendency that wettability of the most internal layer which is directly contacted with ink is worse, it is not effective means for essentially reducing the ink remaining because the cases that the ink remaining practically occurs are triggered by the case that a solid band pattern is printed suddenly in the condition that the ink tank is almost empty, or the case of a combination of such condition and the condition of low temperature environment in winter, or a suction recovery operation of the main body of the printer.

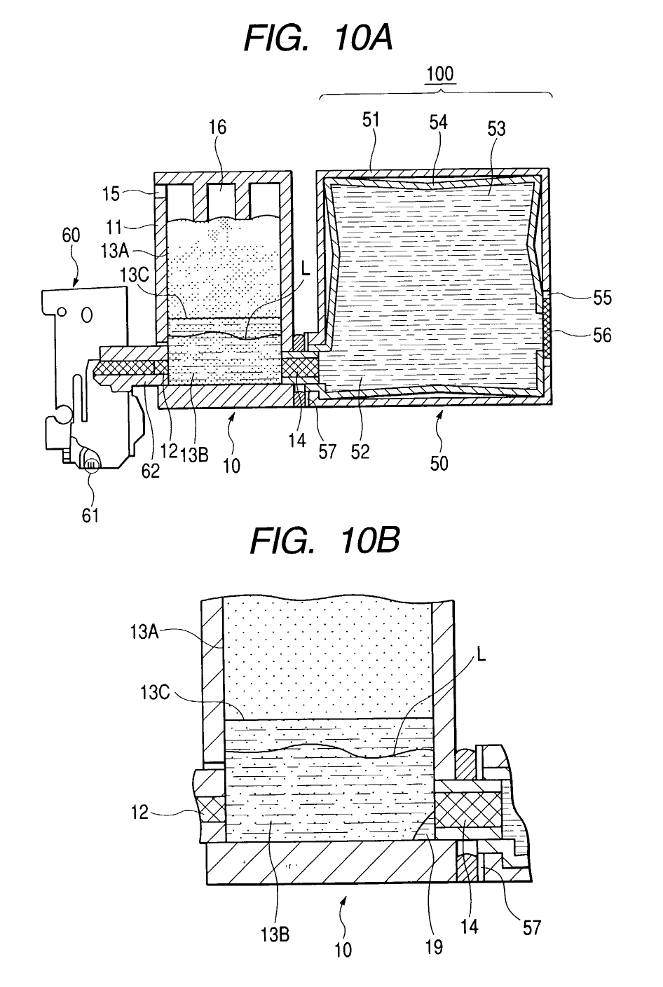

It is known that the constitution of the most internal layer as in the examples, in which the surface energy distributes locally, is effective for supplying the ink successively until the ink tank is empty while being in response to such sudden changes rather than a single composition layer. Moreover, for the sticking phenomenon of the coloring material component of the ink, similar facts were confirmed and another large advantage of the present invention were obtained. Moreover in FIGS. 10A and 10B, the example of other ink supply system using the liquid storage container of the present invention is shown. In this example, while a negative pressure control room for performing a gas-liquid exchanging operation cooperated with the liquid storage container is provided between the liquid storage container and the recording head, similar results can necessarily be obtained.

Further supplement is made on the ink remaining. The ink having low surface tension is easily wettable to the wall surface of the most internal layer, so it is apt to remain on the surface. However, although the ink remains wetly over a wide area as a film, the amount of the remained ink is in an almost negligible level. On the other hand, although the ink having high surface tension (for example, the pigment ink of this example) is hardly wettable, in the region near the liquid supply portion, when the liquid is supplied suddenly, the condition of “part in tears” occurs at either of a downstream side of the ink supply port (recording head side) and an upstream side of the ink supply portion (ink storage side), and thus some amount of the liquid was possibly apt to be remained. It is further possible particularly at a lower temperature side where viscosity is increased (refer to 603 in FIG. 13C).

The present invention intends to stress the wettability of the ink within the ink storage in order to balance pulling at each other by the negative pressure of the ink in the upstream and the downstream of the ink supply port little by little. So to speak, as a comparison, it is similar to a tag of war, in which, when suddenly drawn by opponent, a rope is carried off at a blast even if proponent tries to brace the legs on a ground and its terminal person is left behind, on the contrary, if there are several points on which the proponent can brace the legs while being drawn suddenly, the proponent is dragged slowly and steadily, eventually is dragged into the opponent side rope and all.

For further supplement, comparing between Example P and Example Q, or taking account of a combination of PP and PE, in the configuration of the sea-island in which PP is rich, that is, sea component is PP and island component is PE, the sea component PP dominantly determines a basic property except for the impact resistance, for the impact resistance, the island component PE effectively improves the brittleness of the PP even if the thickness of the most internal layer is same, in addition the amount of the remained ink can be reduced because the PP having a larger back contact angle is the sea component and the PE as the island component forms the local distribution.

On the other hand, the supplement is made on the sticking and the dying. Conventionally, for the liquid storage container, attention has been directed to dissolution of the material, which affects on the stored liquid, from the most internal layer as the liquid resistance layer, and the like, the inventors found an issue that a specific component of the stored liquid is adhered to the most internal layer and dyed, and have studied on this issue which was hard to be solved in the single material configuration, and reached to completion of the present invention. Spatial relief of the wettability between the local areas of the most internal layer and the stored material due to the sea-island structure acts effectively on this issue as seen in the aforementioned examples.

A valve structure having a closing motion function is arranged in the ink supply portion which is only one opening of the tank, for which material can be selected from same types of the materials for the most internal layer. That is, if the most internal layer is selected as the polymer blend of the sea-island structure having the PP of 75% and the PE of 25%, the same blend resin is certainly available, but the sea material, PP can be also selected.

Herein, the supplement is made on the miscibility. When a plurality of polymer resins, each of which has a different molecular structure, are blended each other, they may not form a single phase, but form two separated phases. It can be recognized by optically observing the difference of respective refraction indexes, or measuring their glass-transition temperatures. There is a certain degree of miscibility, that can be called as compatibility, where the resins are properly dispersed, though they are not so miscible that they entangle on the molecular level to behave like a homogeneous system.

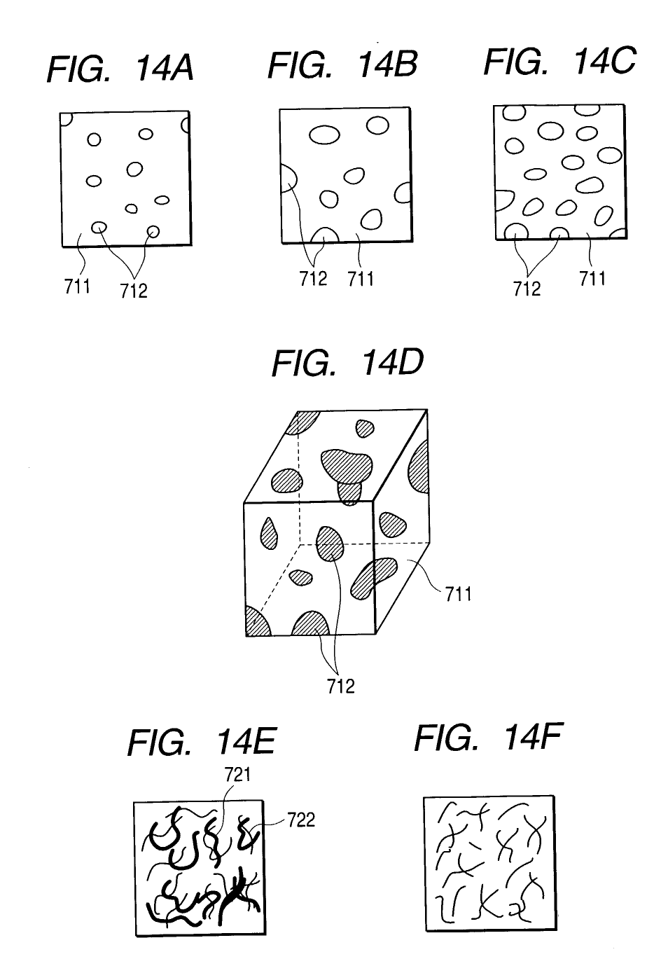

Then, the resins applicable for the present invention include the homopolypropylene (homo-PP), the ethylene-propylene random copolymer (random copolymer PP), the high density polyethylene (HDPE), the medium density polyethylene (MDPE), the low density polyethylene (LDPE), the straight chain low density polyethylene (LLDPE), the very low density polyethylene (VLDPE), and the ultra high molecular weight polyethylene (UHMWPE). These are resins forming a single phase (refer to FIG. 14F).

On the other hand, the ethylene-propylene block copolymer (block copolymer PP), which is essentially the blend system between respective polymers unlike with the random copolymer polypropylene, is a polymer which has molten and pelletized in polymer makers, and essentially behaves as a miscible, single phase system because the polymers have been micro-blended. (The heavy line 721 and the thin line 722 in FIG. 14E schematically illustrates an aspect that respective molecules entangle each other.)

The present invention drew out the advantages of the invention by making the resins, selected from the above olefin-based resins as the resins which may entangle each other rather than never miscible resins, into the proper miscible condition to form the sea-island structure. (Each of FIGS. 14A, 14B, 14C forms the sea-island structure, although a size of the island and space occupation ratio between the sea and the island are different respectively. FIG. 14D is a 3-dimensional, schematic view.)

Moreover, it is known that if the size of the island is several micrometers or more, the drop and impact resistance effect and a lotus leaf effect are clearly exhibited.

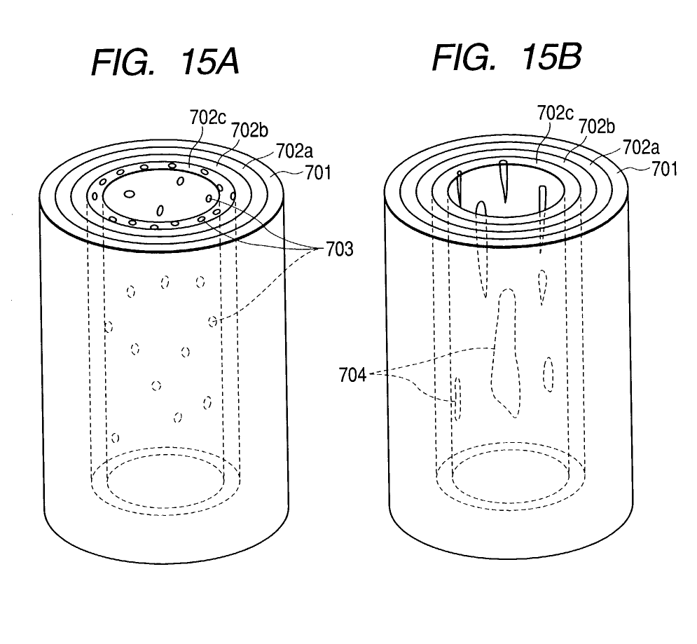

On the other hand, if shear loaded within the head for forming multi-layered structure arranged in the extruder or at the outlet of each extruder is weak, caution must be paid because respective resins do not form the sea-island structure sufficiently and become a whitened layer as a whole, the layer being perfectly separated into two layers. Herein, FIG. 15A is the schematic view showing the island 703 in the parison from which the desired sea-island structure can be obtained as described heretofore. Furthermore, FIG. 15B is the schematic view illustrating uneven distributed island component 704, which doesn't exhibit the neat island 703 state like FIG. 15A. While the constitution shown in FIG. 15A is more preferable, the advantages of the sea-island structure of the present invention can be expected even from the constitution shown in FIG. 15B.

While the best mode of this embodiment is the constitution shown in Example S, it has some complexity because for example, a fluorine-based water-repellent agent must be sprayed to the most internal wall layer of the molding. Therefore, the level of Example P, which provides practically sufficient advantages, is preferable (refer to FIG. 13A).

Next, fabricating methods of the ink tank in this example is described in detail.

The present invention provides the ink tank, which uses a double-wall structure made of the synthetic resins and is reinforced by increasing thickness of the outer wall, on the other hand, which makes it possible to follow a volume variation of the ink stored inside by using a soft material for the inner wall and besides reducing the thickness of the inner wall. The materials for use in respective walls are desirable to be designed such that the inner wall has the ink resistance, and the outer wall has the impact resistance and the like. Since the inner wall stores the ink directly, weak portions commencing with the pinch-off portions necessarily required to have the impact resistance.

In this example, the blow molding method was used for fabricating the ink tank. This is for the purpose of forming the walls constituting the ink tank from substantially not drawn resins. This allows the inner wall of the ink tank constituting the ink storage to withstand the load that is approximately uniform to any directions. Therefore, in particular, even if the ink stored by the inner wall of the ink tank, which has been consumed in some degree, fluctuates in either direction, the inner wall of the ink tank can securely hold the ink, leading to total improvement of the durability of the ink tank.

The blow molding methods include the method using an injection blow, the method using the direct blow, and the method using a double-wall blow. In this example, the direct blow molding method was used.

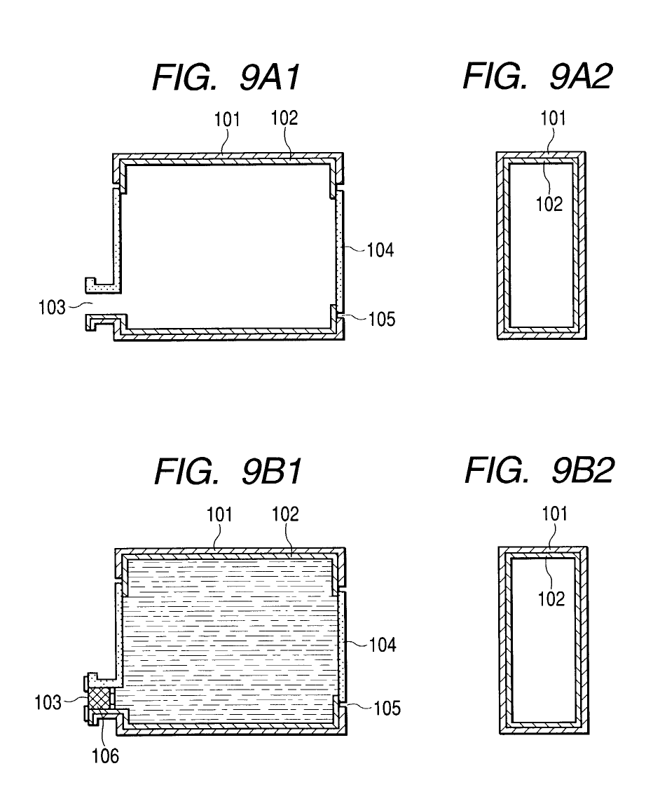

The fabrication process of the ink tank in this example is described in detail with reference to FIGS. 8A to 8D, 9A1 to 9B2.

Each of FIGS. 8A to 8D show the fabrication processes of the ink tank in this example, and FIGS. 9A1 to 9B2 are diagrammatic illustrations showing the condition of the ink tank during the fabrication process of the ink tank, where subscript 1 indicates the surface of maximum area of the ink tank, and subscript 2 indicates a cross section parallel to an edge of the ink tank at the center of the ink tank at that time.

In FIG. 8A, mark 202 illustrates the first extruder for extruding the resin for the most internal layer of the inner wall, and mark 204 illustrates the fourth extruder for extruding the resin for the outer wall. The second extruder for extruding the layer adjacent to the most internal layer, and the third extruder for extruding the layer of the inner wall resins, which is adjacent to such layer and adjacent to the outer wall layer are arranged vertically between extruders 202 and 204, however, they are not shown for simplicity in the drawing. Although the extruder 202 is drawn larger in the drawing, that's not significant. To stretch a point, the first extruder 204 for giving a larger thickness of the molding layer is properly in a same size or slightly bigger.

First, the resins extruded from respective extruders are formed in a cylindrical ring shape, then the second to the fourth resin are stacked on the outer cylindrical surface of the first resin in turn, and an integrated combination of the first, the second, the third, and the fourth parisons in turn from the lower end of the head die 206 is provided. Since the first, the second, and the third parisons are the layers constituting the inner wall, and the fourth parison is the layer constituting the outer wall, each of the third and the fourth resins must be selected to be materials that do not weld each other at their contact surfaces, or must be formed to be disengageable later by adding another layer which generates a cohesive failure. In this example, the former is used for the constitution.

Specifically, in the constitution, the first layer was the ink resistance layer (crystal olefin resin), the second layer was the ambient-temperature-change resistance layer (amorphous polyolefin resin layer), and the third layer was the oxygen permeation resistance layer (ethylene-vinylalcohol copolymer (EVOH)). Moreover, the modified olefin resin may be added to the second layer as a functional adhesive resin, if necessary.

Then, a plurality of resins supplied to the fusion extruder for the first layer was previously dry-blended in the state of pellet. When the blended pellets are supplied into a hopper of the fusion extruder, they are kneaded together, and it is confirmed that the most internal layer (the first layer) of the four-layered parison extruded from the outlet of the head is the sea-island structure. A relievable confirmation means includes observation using a transmission electron microscope or a polarization microscope. The conditions for forming the comparatively large scale sea-island structure was easy to be found, moreover large difference didn't exist in a range of the pellet size from 0.5 mm to prevalent 3 mm square, although it depends on the blend ratio. Moreover, the conditions of the extruder were not restrained significantly. While this is considered to be related with the fact that the forming conditions were determined aiming to form the thin layer of about 10 to 30 μm as the first layer, the conditions may be properly set depending on the thickness of the layer. Although a small-size extruder having screw diameters of 25 to 20 is used here, the extruder is not limited to this.

Next, relative to the integrated parison 207, the die 208 arranged to clip the parison moves so as to change the state shown in FIGS. 8B and 8C, and pinches the parison 207. The portion where the parison is approximately fully pinched by the die and becomes in a cut-off state is the pinch-off portion 104, at which the inner wall formed of the first, the second, and the third layers is closed, while the outer wall formed of the fourth layer, which holds the inner wall, is not closed.

Then, the blow air is injected through an air nozzle 209 as shown in FIG. 8C, and the blow molding is performed in the shape accommodated to the cavity profile of the die 208. The schematic views of the ink tank state at that time are shown in FIGS. 9A1, 9A2. In this state, any of the four layers are in close contact condition.

When the terminal fluorinated resin and the silicone-modified resin are provided on the island of the sea-island structure, it was done according to the following procedure. That is, functional group added polyolefin resins released as interlayer adhesives are blended and molded, and the water repellent resin is sprayed or coated onto the functional group added polyolefin resin, which formed the island (or sea) of the most inner layer of the molding and bonded selectably to the island only.

Next, the ink is injected from the ink supply portion 103, and the ink discharge-enabling member 106 is installed. The diagrammatic views of the ink tank state after the ink has been injected are shown in FIGS. 9B1, 9B2. After that, by pressing the center of the maximum area surface of the outer wall and the like, the adhesion between the fourth layer forming the outer wall and the third layer forming the inner layer and adjacent to the fourth layer becomes weak and the layers separate so slightly, resulting in a disengageable state.

The ink tank of this example was fabricated according to the above process. As the prior art problems, the description has been made especially on the welding strength of the pinch-off portion in the direct blow molding method, however, the advantages of the present invention include a new advantage such as the prevention of the adhesion and sticking of the stored ink as described in Example 3. From these viewpoints, the fabrication methods of the hollow molding of the present invention are not limited to the direct blow molding method (extrusion blow molding method), and include an injection blow molding method, an injection draw blow molding method, an extrusion draw blow molding method, and the like, also are not limited to an hot parison method and a cold parison method and the like.

Moreover, the polypropylene block copolymer (ethylene-propylene copolymer), which is different from the random copolymer and essentially the blend system of respective polymers, is fused and pelletized in polymer makers, and behaves as the essentially miscible, uniform system because the polymers are micro-blended.

On the other hand, if the shear loaded within the head for forming multi-layered structure arranged in the extruder or at the outlet of each extruder is weak, the caution must be paid because respective resins do not form the sea-island structure sufficiently and become the whitened layer which is perfectly separated into two layers.

As described above, the liquid storage container of the present invention is configured as a closed space due to the pinch-off portion, and makes it possible to realize the sufficient reliability to withstand the drop and impact even at low temperature, though it is a thin resin bag for storing the ink and generating the stable negative pressure.

Moreover, the liquid storage container of the present invention makes it possible to supply the ink within the ink tank approximately fully, even under conditions of sudden supply of the ink for printing to the recording head, and the sudden supply of the ink accompanied with the suction recovery operation. Further, it makes it possible to prevent that the ink component adheres and precipitates to the inside of the inner wall to reduce the visibility, or allow a detection mechanism of the remained ink amount to be malfunctioned under preservation at high temperature.

What is claimed is:

1. A liquid storage container comprising an inner wall for forming a liquid storage portion for storing a liquid therein, an outer wall for forming a liquid storage portion housing chamber for housing the liquid storage portion, and a liquid supply portion for supplying a liquid from the liquid storage portion to the outside,
wherein the inner wall has a structure in which at least one layer is laminated over the entire inner wall region, and is a member which can deform with discharge of the liquid to generate a negative pressure in the liquid storage portion; the most internal layer of the layers constituting the inner wall of a pinch-off portion is made of a polymer blend of one or more resins selected from the first group, which is usually used as a polypropylene, consisting of a homopolypropylene (homo-PP), an ethylene-propylene random copolymer (random copolymer PP) and an ethylene-propylene block copolymer (block copolymer PP), and one or more resins selected from the second group, which is usually used as a polyethylene, consisting of a high density polyethylene (HDPE), a medium density polyethylene (MDPE), a low density polyethylene (LDPE), a straight chain low density polyethylene (LLDPE), a very low density polyethylene (VLDPE) and an ultra high molecular weight polyethylene (UHMWPE); and the first group and the second group are constituted as an aggregate of comparatively large scales.

2. The liquid storage container according to claim 1, wherein the most internal layer is made of a polymer blend containing a resin wherein terminal ends of the olefin resin are fluorinated or converted into dimethylsiloxane.

3. The liquid storage container according to claim 1, wherein the inner wall has a laminated structure of two or more layers, and a layer adjacent to the most internal layer is made of such a material that a change of its elastic modulus with a temperature change of an environment used for the liquid storage container wherein the liquid is stored in the liquid storage portion is 25% or less.

4. The liquid storage container according to claim 1, wherein the layer adjacent to the most internal layer is made of a material having a higher elastic modulus and a lower Izod impact strength than the most internal layer.

5. The liquid storage container according to claim 1, wherein the layer adjacent to the most internal layer is made of a cyclic olefin resin.

6. The liquid storage container according to claim 1, wherein the layer adjacent to the most internal layer is made of a random copolymer of ethylene with a tetracyclododecene.

7. A liquid storage container comprising an inner wall for forming a liquid storage portion for storing a liquid therein, an outer wall for forming a liquid storage portion housing chamber for housing the liquid storage portion, and a liquid supply portion for supplying the liquid from the liquid storage portion to the outside,
wherein the inner wall has a structure in which at least one layer is laminated over the entire inner wall region, and is a member which deforms with discharge of the liquid to generate a negative pressure in the liquid storage portion; and the most internal layer of the layers constituting the inner wall of a pinch-off portion is mainly made of a polymer blend of two or more resins selected from polyolefin resins, and these resins are maintained at such a compatible degree as to form a sea-island structure constituted as an aggregate of comparatively large scales.

8. The liquid storage container according to claim 7, wherein the most internal layer is made of a polymer blend of a polypropylene resin and a polyethylene resin.

9. The liquid storage container according to claim 8, wherein the polypropylene resin is one or more resins selected from the first group, which is usually used as a polypropylene, consisting of a homopolypropylene (homo-PP), an ethylene-propylene random copolymer (random PP) and an ethylene-propylene block copolymer (block PP); and the polyethylene resin is one or more resins selected from the second group, which is usually used as a polyethylene, consisting of a high density polyethylene (HDPE), a medium density polyethylene (MDPE), a low density polyethylene (LDPE), a straight chain low density polyethylene (LLDPE), a very low density polyethylene (VLDPE) and an ultra high molecular weight polyethylene (UHMWPE).

10. The liquid storage container according to claim 7, wherein islands of the sea-island structure have a size of at least 3 μm.

11. The liquid storage container according to claim 7, wherein the most internal layer is made of a polymer blend further containing a resin wherein terminal ends of the polyolefin resin are fluorinated or converted into dimethylsiloxane.

12. The liquid storage container according to claim 7, wherein the inner wall has a laminated structure of two or more layers, and a layer adjacent to the most internal layer is made of such a material that a change of its elastic modulus with a temperature change of an environment used for the liquid storage container wherein the liquid is stored in the liquid storage portion is 25% or less.

13. The liquid storage container according to claim 7, wherein the layer adjacent to the most internal layer is made of a material having a higher elastic modulus and a lower Izod impact strength than the most internal layer.

14. The liquid storage container according to claim 7, wherein the layer adjacent to the most internal layer is made of a cyclic olefin resin.

15. The liquid storage container according to claim 7, wherein the layer adjacent to the most internal layer is made of a random copolymer of ethylene with a tetracyclododecene.

16. A liquid storage container comprising a liquid storage portion for storing a liquid therein, and a liquid supply portion for supplying the liquid from the liquid storage portion to the outside,
wherein the inner wall has a structure in which at least one layer is laminated over the entire inner wall region; the most internal layer is mainly made of a polymer blend of two or more resins selected from polyolefin resins; and these resins are maintained at such a compatible degree as to form a sea-island structure constituted as an aggregate of comparatively large scales.

17. The liquid storage container according to claim 16, wherein the most internal layer is made of a polymer blend of a polypropylene resin and a polyethylene resin.

18. The liquid storage container according to claim 17, wherein the polypropylene resin is one or more resins selected from the first group, which is usually used as a polypropylene, consisting of a homopolypropylene (homo-PP), an ethylene-propylene random copolymer (random PP) and an ethylene-propylene block copolymer (block PP); and the polyethylene resin is one or more resins selected from the second group, which is usually used as a polyethylene, consisting of a high density polyethylene (HDPE), a medium density polyethylene (MDPE), a low density polyethylene (LDPE), a straight chain low density polyethylene (LLDPE), a very low density polyethylene (VLDPE) and an ultra high molecular weight polyethylene (UHMWPE).

19. The liquid storage container according to claim 16, wherein islands of the sea-island structure have a size of at least 3 μm.

20. A method for manufacturing a liquid storage container having an inner wall forming a liquid storage portion for storing a liquid therein, an outer wall forming a liquid storage portion housing chamber for housing the liquid storage portion, and a liquid supplying portion for supplying the liquid from the liquid storage portion to the outside,
wherein the inner wall is integrally formed together with the outer wall by direct blow molding; the inner wall is a member which can deform with the discharge of the liquid to generate a negative pressure in the liquid storage portion; and the most internal layer of the layers constituting the inner wall of a pinch-off portion (welded portion) is bonded to a resin layer having a sea-island structure constituted as a relatively large scale aggregate containing a polymer blend of two or more resins selected from polyolefin resins.

21. The method for manufacturing the liquid storage container according to claim 20, wherein the most internal layer is made of a polymer blend of a polypropylene resin and a polyethylene resin.

22. The method for manufacturing the liquid storage container according to claim 21, wherein the most internal layer is made of a polymer blend further containing a resin wherein terminal ends of a polyolefin resin is fluorinated or converted into dimethylsiloxane.
